(19) United States
(12) Patent Application Publication
(10) Pub. No.: US 2010/0023191 A1
(43) Pub. Date: Jan. 28, 2010

(54) METHOD AND APPARATUS FOR WIRELESS RUNWAY INCURSION DETECTION

(75) Inventor: Rolf STEFANI, West River, MD (US)

Correspondence Address: PRASS LLP, 2661 Riva Road, Bldg. 1000, Suite 1044, ANNAPOLIS, MD, 21401, US

(73) Assignee: ARINC INCORPORATED, Annapolis, MD (US)

(21) Appl. No.: 12/177,615

(22) Filed: Jul. 22, 2008

(51) Int. Cl. G08G 5/00

(52) U.S. Cl. 701/21; 701/20; 340/947; 340/907

(57) ABSTRACT

A wireless runway incursion system is disclosed. The wireless runway incursion system method may include a runway traffic management unit that manages aircraft traffic on and around an airport's runways, a plurality of wireless relay devices located between the runway access points and the runway traffic management unit that relay wireless signals to the runway traffic management unit, and a plurality of wireless runway incursion sensors that are located in proximity of at least one airport runway that detect metallic objects. If a metallic object is detected, the wireless runway incursion sensors that detect the metallic object send signals to the runway traffic management unit, the wireless signal being an indication that the metallic object is one of entering the runway and leaving the runway.

### BACKGROUND OF THE DISCLOSURE

1. Field of the Disclosure

The disclosure relates to runway traffic management at airports.

2. Introduction

Conventional runway incursion detection systems have many drawbacks. First of all, the cost to install and deploy a sensor network to cover all access points for runways is too great to allow many airports to install such systems. Typically, any sensor technology requires costly construction activity in order to bury wire for power and communications from terminal buildings and air traffic control facilities to the network of sensors required to provide effective monitoring of all access paths to all the runways at airports.

Other technologies (without the hardwired expense of sensor networks) require purchase, installation and services to GPS based transceiver devices (often called “squitters”) to all vehicles that are on the air side of an airport terminal (“air side” is the area on the airport property that has access to the aircraft at gates as well as on the ramps, taxiways and runways). A large airport may have more than 1,000 vehicles and pieces of equipment that require tracking by squitters which is also very expensive (e.g., at $2000 per squitter, 1000 vehicles would be more than $2 million of squitters)

### SUMMARY OF THE DISCLOSURE

A wireless runway incursion system is disclosed. The wireless runway incursion system method may include a runway traffic management unit that manages aircraft traffic on and around an airport's runways, a plurality of wireless relay devices located between the runway access points and the runway traffic management unit that relay wireless signals to the runway traffic management unit, and a plurality of wireless runway incursion sensors that are located in proximity of at least one airport runway that detect metallic objects. If a metallic object is detected, the wireless runway incursion sensors that detect the metallic object send signals to the runway traffic management unit, the wireless signal being an indication that the metallic object is one of entering the runway and leaving the runway. The wireless runway management unit may receive one or more signals from at least one of the plurality of wireless runway incursion sensors through at least one of the wireless relay devices indicating that a metallic object is one of entering a runway and leaving a runway, may send a notification to a ground control operator that the runway is occupied based on the one or more received signals, determines that the metallic object has cleared the runway, and may send a notification to ground control that the metallic object has cleared the runway based on the cleared runway determination.

### BRIEF DESCRIPTION OF THE DRAWINGS

In order to describe the manner in which the above-recited and other advantages and features of the disclosure can be obtained, a more particular description of the disclosure briefly described above will be rendered by reference to specific embodiments thereof which are illustrated in the appended drawings. Understanding that these drawings depict only typical embodiments of the disclosure and are not therefore to be considered to be limiting of its scope, the disclosure will be described and explained with additional specificity and detail through the use of the accompanying drawings in which:

FIG. 1 is an exemplary diagram of a wireless runway incursion detection system in accordance with a possible embodiment of the disclosure;

FIG. 2 is a diagram of an exemplary wireless runway incursion sensor in accordance with a possible embodiment of the disclosure; and

FIG. 3 is a diagram of an exemplary wireless runway incursion sensor location in accordance with a possible embodiment of the disclosure;

FIG. 4 is a diagram of the exemplary wireless runway incursion sensor in accordance in accordance with a possible embodiment of the disclosure;

FIG. 5 is a diagram of an exemplary wireless relay device in accordance with a possible embodiment of the disclosure;

FIG. 6 is a diagram of an exemplary runway traffic management unit in accordance with a possible embodiment of the disclosure;

FIG. 7 is an exemplary block diagram of the runway traffic management unit in accordance with a possible embodiment of the disclosure;

FIG. 8 is an exemplary diagram of an airport environment implementing the wireless runway incursion detection system in accordance with a possible embodiment of the disclosure;

FIG. 9 is a flowchart of an exemplary wireless runway incursion detection process in accordance with a possible embodiment of the disclosure;

FIG. 10 is an exemplary diagram of an aircraft approaching a wireless runway incursion sensor array in accordance with a possible embodiment of the disclosure;

FIG. 11 is an exemplary diagram of an aircraft being detected by the wireless runway incursion sensor array in accordance with a possible embodiment of the disclosure; and

FIG. 12 is an exemplary diagram of an aircraft clearing the wireless runway incursion sensor array in accordance with a possible embodiment of the disclosure.

### DETAILED DESCRIPTION OF THE DISCLOSURE

Additional features and advantages of the disclosure will be set forth in the description which follows, and in part will be obvious from the description, or may be learned by practice of the disclosure. The features and advantages of the disclosure may be realized and obtained by means of the instruments and combinations particularly pointed out in the appended claims. These and other features of the present disclosure will become more fully apparent from the following description and appended claims, or may be learned by the practice of the disclosure as set forth herein.

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure.

The disclosure comprises a variety of embodiments, such as a method and apparatus and other embodiments that relate to the basic concepts of the disclosure.

This disclosure concerns a system and method to determine if airport runways are occupied or empty of vehicles, airport equipment, aircraft, etc. The disclosure focuses on recently-developed sensor and communications technologies that may be used together to address the issue of avoiding runway collisions between aircraft landing or taxiing with other vehicles or aircraft that may, from time to time, occupy the active runway.

The disclosed embodiments may provide a wireless, self-powered mesh networked detection and communications modules In particular, a single package may be able to detect vehicles entering or leaving a defined runway and communicate detections to a system wirelessly in near real time all the while being able to operate for years without an external power source.

This instantiation of this may be based on ZigBee. ZigBee is the popular name for the IEEE 802.15.4 standard for an extremely low power, and low bit rate wireless PAN technology, designed for wireless automation and other lower data rate tasks, such as smart home automation and remote monitoring. While the ZigBee communication device may provide wireless communications, it may be coupled with an integrated magnetometer and long duration battery integrated into a small form factor and extremely durable module that can be sealed in concrete or other materials with the capability of withstanding jumbo aircraft wheels to roll over the imbedded device.

The disclosed embodiments provide the integration of Magnetometer, ZigBee transceiver and power into a single sensor device which is deployed in a self-creating and wireless PAN Personal Area Network) to create a communications infrastructure not connected by any wire. The disclose embodiments also provide the capability of detecting objects, direction of movement and size by detecting time differences of sensor detection and communicating the events to a central aircraft traffic management unit that can make use of the information as part of a runway incursion detection system which would drastically reduce the cost of implementation of such a system (e.g., about 10% of the cost of conventional runway incursion systems).

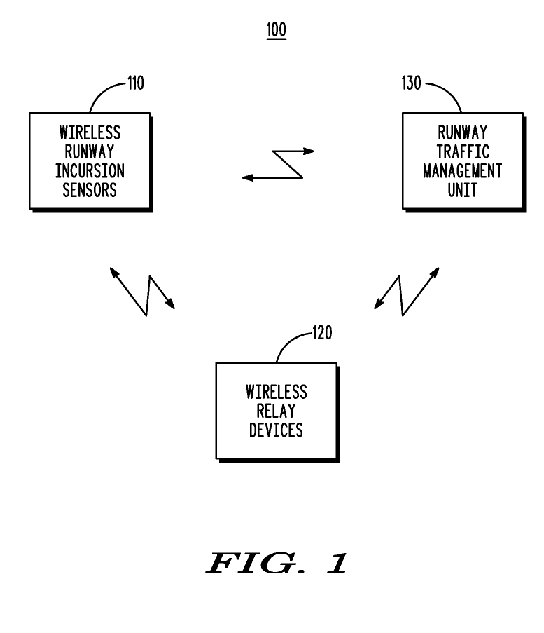

FIG. 1 is an exemplary diagram of a wireless runway incursion detection system 100 in accordance with a possible embodiment of the disclosure. The wireless runway incursion detection system 100 may include a plurality of wireless runway incursion sensors 110 (wireless sensors 110), a plurality of wireless relay devices 120, and one or more runway traffic management unit 130. The plurality of wireless runway incursion sensors 110, the plurality of wireless relay devices 120, and the one or more runway traffic management unit 130 may communicate directly or through a network, for example.

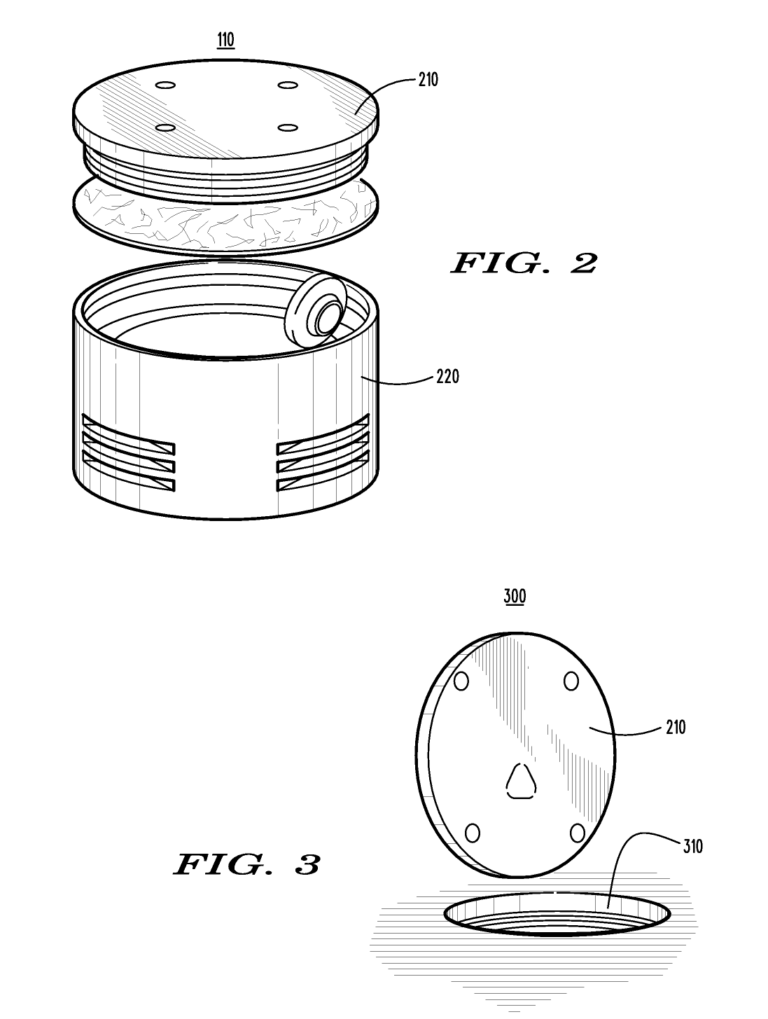

FIG. 2 is a diagram of an exemplary wireless runway incursion sensor 110 in accordance with a possible embodiment of the disclosure. The wireless runway incursion sensor 110 may enclosed in a casing 220 and may include any hard cover 210 that permits large objects to travel over the sensor 110 without inflicting damage, for example.

FIG. 3 is a diagram of an exemplary wireless runway incursion sensor location 300 in accordance with a possible embodiment of the disclosure. A plurality of wireless runway incursion sensors 110 may be placed in individual holes 310 at the access points to a runway, for example. The cover 210 may be flush with the runway access surface. The wireless runway incursion sensors 110 may be arranged in multiple rows (or array), for example.

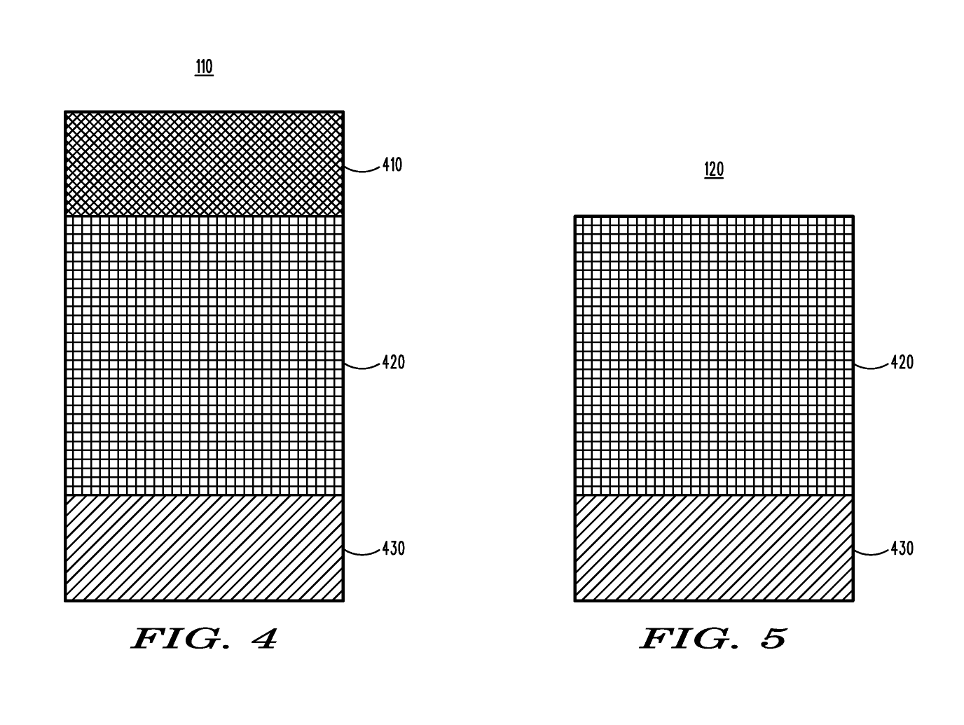

FIG. 4 is a diagram of the exemplary wireless runway incursion sensor 110 in accordance in accordance with a possible embodiment of the disclosure. The wireless runway incursion sensor 110 may include a magnetometer 410, a communication device 420, and a battery 430, for example. The magnetometer 410 may be any device that detects metal objects known to those of skill in the art. The communication device 420 may be any wireless communication device known to those of skill in the art, including a ZigBee IEEE 802.15.4 transceiver. ZigBee is the standard for an extremely low power and low bit rate wireless Personal Area Network (PAN) technology designed for wireless automation and other lower data rate tasks, such as smart home automation and remote monitoring, for example. The battery 430 may be any long life battery (e.g., 10 years) known to those of skill in the art.

FIG. 5 is a diagram of an exemplary wireless relay device 120 in accordance with a possible embodiment of the disclosure. The wireless relay device 120 may include the same communication device 420 and battery 430 as the wireless runway incursion sensor 110 except the wireless relay device 120 does not require a magnetometer 410. Therefore, the wireless relay device 120 may be manufactured less expensively than the wireless runway incursion sensor 110.

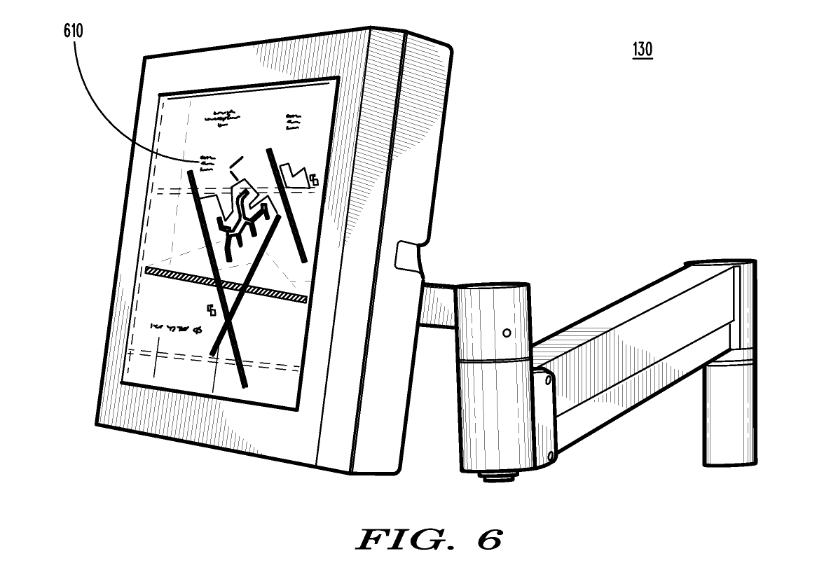

FIG. 6 is an exemplary diagram of a runway traffic management unit 130 in accordance with a possible embodiment of the disclosure. The runway traffic management unit 130 may present a display 610 to a ground control operator, for example, to visually illustrate runway access activity and provide warnings and updates to the operator. The runway traffic management unit 130 may be any computer, server, personal computer, etc. known to one of skill in the art.

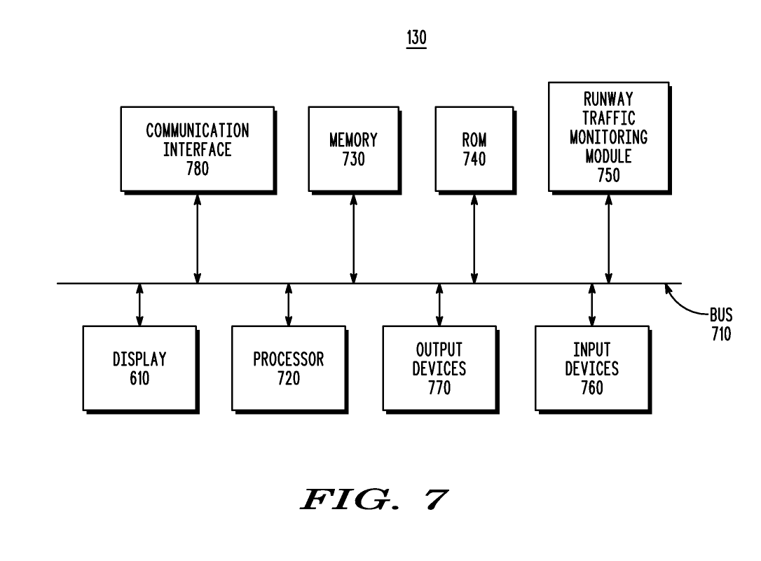

FIG. 7 is an exemplary block diagram of the runway traffic management unit 130 in accordance with a possible embodiment of the disclosure. The runway traffic management unit 130 may include a bus 710, a processor 720, a memory 730, ROM 740, a runway traffic monitoring module 750, input devices 760, output devices 770, a communication interface 780, and the display 610. Bus 310 may permit communication among the components of the runway traffic management unit 130.

Processor 720 may include at least one conventional processor or microprocessor that interprets and executes instructions. Memory 730 may be a random access memory (RAM) or another type of dynamic storage device that stores information and instructions for execution by processor 720. Memory 730 may also store temporary variables or other intermediate information used during execution of instructions by processor 720. Memory 730 may also include any type of media, such as, for example, magnetic or optical recording media and its corresponding drive. ROM 740 may include a conventional ROM device or another type of static storage device that stores static information and instructions for processor 720.

Input devices 760 may include one or more conventional mechanisms that permit a user to input information to the runway traffic management unit 130, such as a keyboard, a mouse, a pen, a voice recognition device, etc. Output devices 770 may include one or more conventional mechanisms that output information to the user, including a printer, one or more speakers, or a medium, such as a memory, or a magnetic or optical disk and a corresponding disk drive. Display 610 may be any display, monitor, etc. known to those of skill in the art.

Communication interface 780 may include any transceiver-like mechanism that enables the runway traffic management unit 130 to communicate via a network. For example, communication interface 780 may include a modem, or an Ethernet interface for communicating via a local area network (LAN). Alternatively, communication interface 780 may include other mechanisms for communicating with other devices and/or systems via wired, wireless or optical connections. In some implementations of the runway traffic management unit 130, communication interface 780 may not be included in the exemplary the runway traffic management unit 130 when the runway traffic management process is implemented completely within the runway traffic management unit 130.

The runway traffic management unit 130 may perform such functions in response to processor 720 by executing sequences of instructions contained in a computer-readable medium, such as, for example, memory 730, a magnetic disk, or an optical disk. Such instructions may be read into memory 730 from another computer-readable medium, or from a separate device via communication interface 780.

The runway traffic management unit 130 illustrated in FIGS. 1, 6 and 7 and the related discussion are intended to provide a brief, general description of a suitable computing environment in which the disclosure may be implemented. Although not required, the disclosure will be described, at least in part, in the general context of computer-executable instructions, such as program modules, being executed by the runway traffic management unit 130, such as a general purpose computer. Generally, program modules include routine programs, objects, components, data structures, etc. that perform particular tasks or implement particular abstract data types. Moreover, those skilled in the art will appreciate that other embodiments of the disclosure may be practiced in network computing environments with many types of computer system configurations, including personal computers, hand-held devices, multi-processor systems, microprocessor-based or programmable consumer electronics, network PCs, minicomputers, mainframe computers, and the like.

Embodiments may also be practiced in distributed computing environments where tasks are performed by local and remote processing devices that are linked (either by hardwired links, wireless links, or by a combination thereof through a communications network. In a distributed computing environment, program modules may be located in both local and remote memory storage devices.

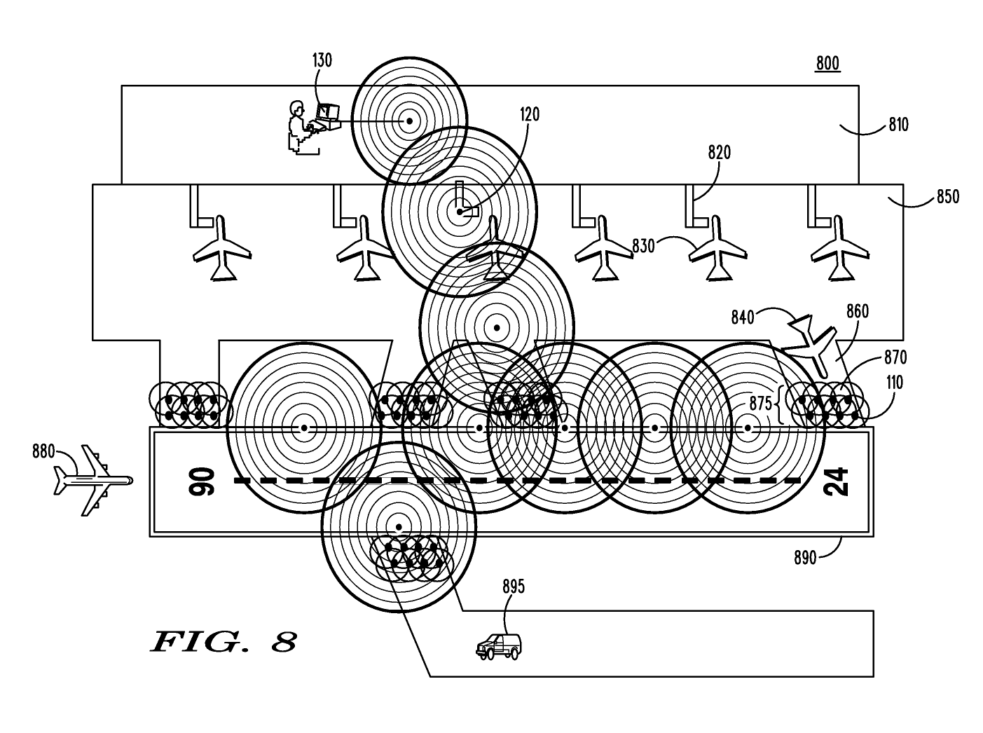

FIG. 8 is an exemplary diagram of an airport environment 800 implementing the wireless runway incursion detection system 100 in accordance with a possible embodiment of the disclosure. The airport environment 800 may include a plurality of wireless runway incursion sensors 110, the plurality of wireless relay devices 120, one or more runway traffic management units 130, aircraft terminal 810, a plurality of airport terminal gates 820, a plurality of aircraft positioned at the gates 830, an aircraft entering a runway 840, an airport ramp 850, an aircraft taxiway 860, sensor coverage area 870 for the wireless runway incursion sensors 110, sensor array 875, runway 890, aircraft preparing to land on the runway 890, and a plurality of airport vehicles 895.

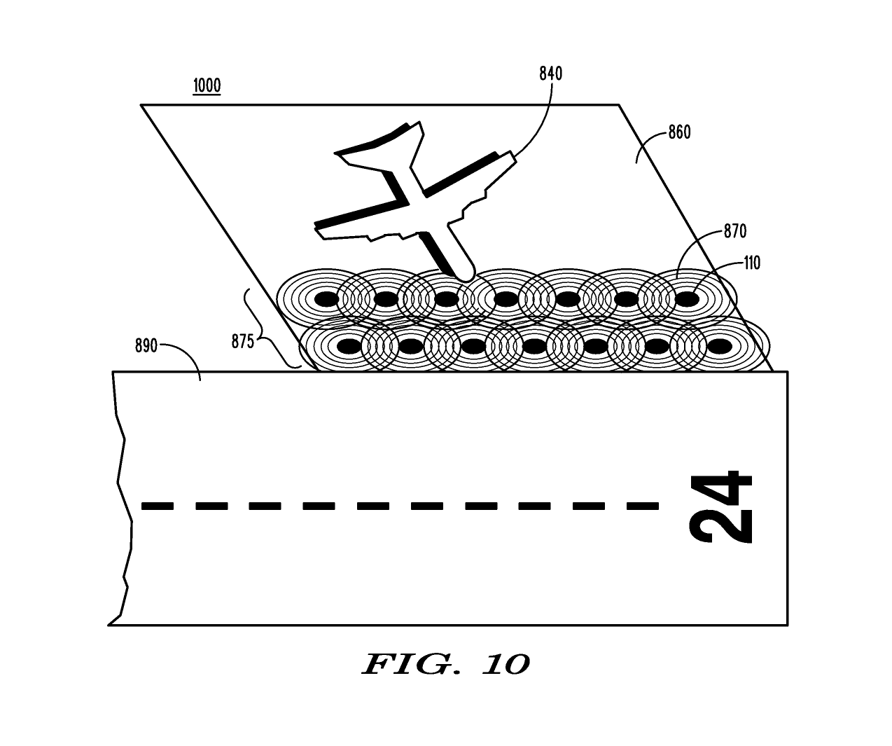

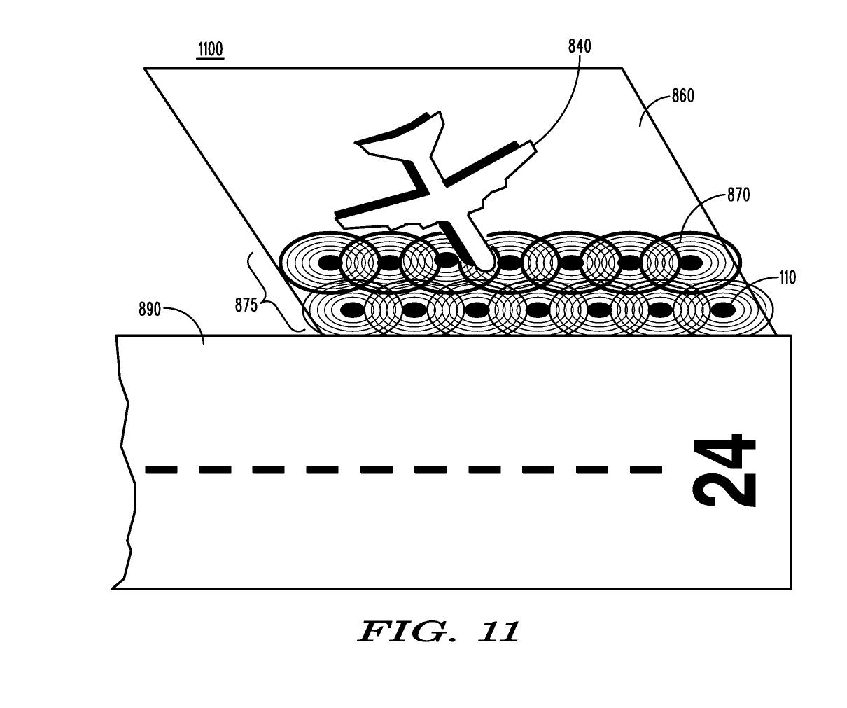

As shown also in FIG. 10, as the aircraft 840 travels from the gates 820 and across the ramp 850, it enters taxiway 860. As shown in FIG. 11, the aircraft 840 is a large metallic object and is detected by the magnetometer 410 of one or more wireless runway incursion sensors 110 in a first row of sensors 110 in the sensor array 875 when the aircraft reaches the edge of its detection area 870 (8-15 feet, for example). Once the wireless runway incursion sensors 110 detect the aircraft 840, the communication devices 420 of the wireless runway incursion sensors 110 send wireless messages either directly or through wireless relay devices 120 to the runway traffic management unit 130.

Since the aircraft 840 is detected by the row of sensors 110 in the sensor array 875 closest to the terminal (away from the runway 890), the runway traffic management unit 130 knows that the aircraft is entering the runway 890. Therefore, the runway traffic management unit 130 will not indicate that the runway 890 is clear until receiving an Aircraft Communications Addressing and Reporting System (ACARS) message from the aircraft 840 stating that it is airborne or receiving information from other surveillance systems, such as radar, Global Positioning Systems (GPS), Automatic Dependent Surveillance Broadcast (ADS-B), for example. In addition, the runway traffic management unit 130 may determine that the aircraft 880 has landed on the runway using these other surveillance systems, as well.

If aircraft 880 lands on runway 890 and attempts to taxi to the gates 820 using a taxiway 860, the aircraft 880 may be sensed by the row of wireless runway incursion sensors 110 in the sensor array 875 that are closest to the runway 890 first. Then, the row of wireless runway incursion sensors 110 closest to the terminal will detect the aircraft 890. As such, the runway traffic management unit 130 will know that the aircraft 880 will be leaving (or clearing) the runway 890.

Since the position, spacing, and detection range of the wireless runway incursion sensors 110 is known, the runway traffic management unit 130 may determine the size, direction and speed of the object. For example, depending on which row and wireless sensors 110 in the row detect the object first and then which row and sensors detect the object second, the runway traffic management unit 130 can determine the direction of the object. Depending on how many wireless sensors 110 across detect the object, the width of the object may be determined. Depending on when and for how long a wireless sensor 110 detects the object, may determine its length. In addition, the time between detection by one or more sensor in the first row of wireless sensors 110 in the array 875 and detection by the second row may determine the objects speed.

While the wireless sensors 110 are shown to be next to the runway on the aircraft access points, the wireless sensors 110 may be located anywhere in the “air side” of the terminal, including the ramp, tarmac, gates, wash racks, hangars, etc. within the spirit and scope of the invention. Thus, a traffic management unit may be able to track other vehicles and aircraft anywhere around the airport environment 100 using the wireless sensor 110 (and relay device 120) and tracking technology.

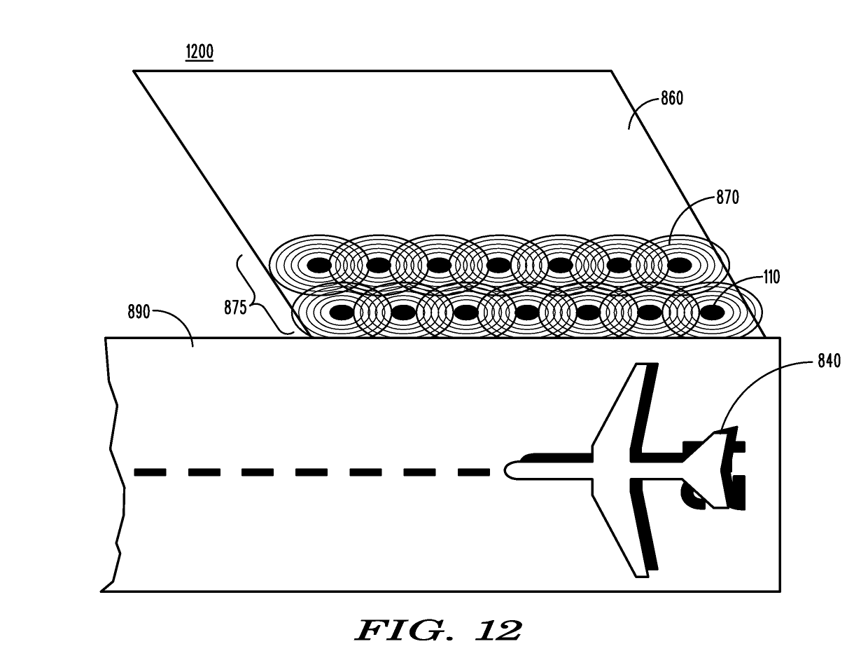

FIG. 12 shows the aircraft on the runway 890. Although the wireless runway incursion sensors 110 may no longer sense the aircraft 840 as it is out of range, the runway traffic management unit 130 will know that be runway is obstructed until an ACARS take off message (or information received from other surveillance systems) is received from the aircraft 840.

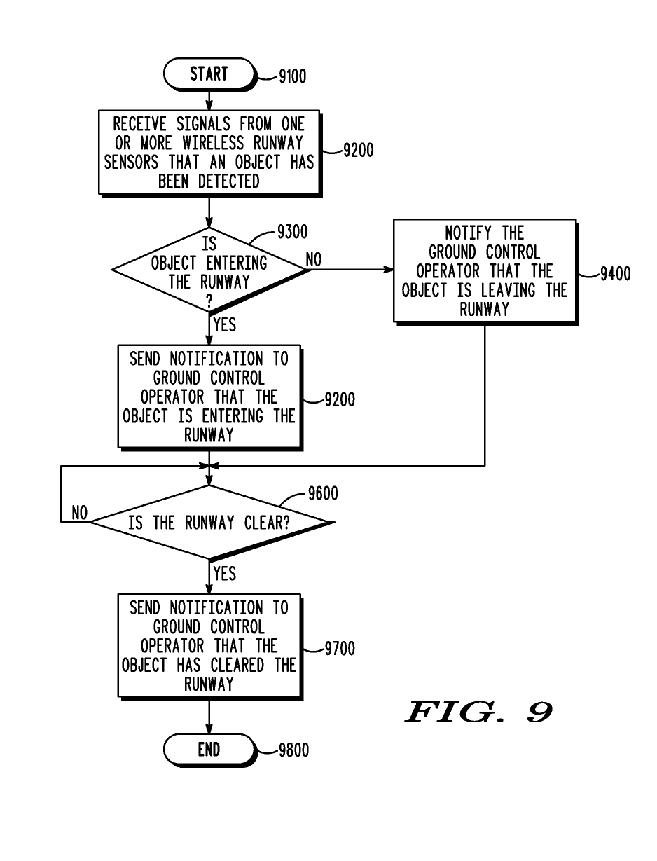

The operation of the runway traffic management unit 130, the runway traffic monitoring module 750, and the exemplary wireless runway incursion detection process is described in FIG. 9 with respect to FIGS. 1-8 and 10-12.

FIG. 9 is a flowchart of an exemplary wireless runway incursion detection process in accordance with a possible embodiment of the disclosure. The process begins at step 9100, and continues to step 9200 where the runway traffic monitoring module 750 may receive signals from one or more wireless runway incursion sensors 110 that a metallic object has been detected. The received signals may be relayed to the runway traffic monitoring module 750 through the wireless relay devices 120.

At step 9300, the runway traffic monitoring module 790 may determine if the object is entering the runway 890. If the runway traffic monitoring module 750 determines that be aircraft object is not entering the runway 890, at step 9400, the runway traffic monitoring module 750 may notify a ground control operator that the object is leaving the runway 890. If at step 9300, the runway traffic monitoring module 750 determines that the object is entering the runway, at step 9500, the runway traffic monitoring module 750 may send a notification to the ground control operator that the object is entering the runway.

At step 9600, the runway traffic monitoring module 750 may determine if the runway 890 is clear. The runway traffic monitoring module 750 may determine if the runway 890 is clear if it receives an ACARS message from the aircraft 840 stating that it has taken off and is airborne. Alternatively, the runway traffic monitoring module 750 may determine that be aircraft 840 (or other object, such as a vehicle) is leaving the runway 890.

If at step 9600, the runway traffic monitoring module 750 determines that the runway 890 is not clear, the process return to step 9600. If at step 9600, the runway traffic monitoring module 750 determines that the runway 890 is clear, at step 9700, the runway traffic monitoring module 750 may send a notification ground control operator that the object has cleared the runway. The process then goes to step 9000 and ends

Embodiments within the scope of the present disclosure may also include computer-readable media for carrying or having computer-executable instructions or data structures stored thereon. Such computer-readable media can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures. When information is transferred or provided over a network or another communications connection (either hardwired, wireless, or combination thereof to a computer, the computer properly views the connection as a computer-readable medium. Thus, any such connection is properly termed a computer-readable medium. Combinations of the above should also be included within the scope of the computer-readable media.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, objects, components, and data structures, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Although the above description may contain specific details, they should not be construed as limiting the claims in any way. Other configurations of the described embodiments of the disclosure are part of the scope of this disclosure. For example, the principles of the disclosure may be applied to each individual user where each user may individually deploy such a system. This enables each user to utilize the benefits of the disclosure even if any one of the large number of possible applications do not need the functionality described herein. In other words, there may be multiple instances of the components of the disclosed embodiments each processing the content in various possible ways. It does not necessarily need to be one system used by all end users. Accordingly, the appended claims and their legal equivalents should only define the disclosure, rather than any specific examples given.

What is claimed is:

1. A method for runway traffic management using a wireless runway incursion system, comprising:
receiving one or more signals from one or more wireless runway incursion sensors that a metallic object has entered a runway;
sending a notification to a ground control operator that the runway is occupied based on the one or more received signals;
determining that the metallic object has cleared the runway; and
sending a notification to ground control that the metallic object has cleared the runway based on the cleared runway determination.

2. The method of claim 1, wherein the runway is determined to be clear if one of a message is received from the aircraft and one or more signals from one or more wireless runway incursion sensors are received.

3. The method of claim 1, wherein the sensors are in-ground and located at the access points of the runway.

4. The method of claim 1, wherein the one or more signals from one or more wireless runway incursion sensors are received through one or more wireless relay devices.

5. The method of claim 1, further comprising:
determining at least one of the size, speed, and direction of the metallic object.

6. The method of claim 5, wherein the determined direction determines if the metallic object is entering or leaving the runway.

7. The method of claim 1, wherein the received signals are IEEE 802.15.4 signals.

8. A runway traffic management unit using a wireless runway incursion system, comprising:
a communication interface; and
a runway traffic monitoring module that receives one or more signals from one or more wireless runway incursion sensors through the communication interface that a metallic object is one of entering a runway and leaving a runway, and sends a notification to a ground control operator through the communication interface that the runway is occupied based on the one or more received signals, and determines that the metallic object has cleared the runway, and sends a notification to ground control through the communication interface that the metallic object has cleared the runway based on the cleared runway determination.

9. The runway traffic management unit of claim 8, wherein runway traffic monitoring module determines that the runway is clear if one of a message is received from the aircraft and one or more signals from one or more wireless runway incursion sensors are received.

10. The runway traffic management unit of claim 8, wherein the sensors are in-ground and located at the access points of the runway.

11. The runway traffic management unit of claim 8, wherein the runway traffic monitoring module receives the one or more signals from one or more wireless runway incursion sensors through one or more wireless relay devices.

12. The runway traffic management unit of claim 8, wherein the runway traffic monitoring module determines at least one of the size, speed, and direction of the metallic object.

13. The runway traffic management unit of claim 12, wherein the determined direction determines if the metallic object is entering or leaving the runway.

14. The runway traffic management unit of claim 8, wherein the received signals are IEEE 802.15.4 signals.

15. A wireless runway incursion sensor that detects metallic objects in proximity of a runway at an airport, comprising:
a magnetometer that detects metallic objects in its proximity;
a wireless communication device that sends a wireless signal to a runway traffic management unit that a metallic object has been detected, the wireless signal being an indication that the metallic object is one of entering the runway and leaving the runway; and
a battery that supplies power to the magnetometer and the wireless communication device.

16. The wireless runway incursion sensor of claim 15, wherein a plurality wireless runway incursion sensors are located in multiple rows.

17. The wireless runway incursion sensor of claim 15, wherein the wireless runway incursion sensors are in-ground and located at the access points of the runway.

18. The wireless runway incursion sensor of claim 15, wherein the communication device sends the one or more wireless signals to the runway traffic management unit through one or more wireless relay devices.

19. The wireless runway incursion sensor of claim 15, wherein at least one of the size, speed, and direction of the metallic object are determined based on the signals sent to the runway traffic management unit by the communication device.

20. The wireless runway incursion sensor of claim 19, wherein the determined direction determines if the metallic object is entering or leaving the runway.

21. The wireless runway incursion sensor of claim 8, wherein the signals sent by the communication device are IEEE 802.15.4 signals.

22. A wireless relay device located in proximity of a runway at an airport, comprising:
a wireless communication device that receives wireless signals from one or more wireless runway incursion sensors and sends the wireless signals to a runway traffic management unit that a metallic object has been detected, the wireless signal being an indication that the metallic object is one of entering the runway and leaving the runway; and
a battery that supplies power to the wireless communication device.

23. The wireless relay device of claim 22, wherein the wireless relay devices are located between the runway access points and the runway traffic management unit.

24. A wireless runway incursion system, comprising:
a runway traffic management unit that manages aircraft traffic on and around an airport's runways;
a plurality of wireless relay devices located between the runway access points and the runway traffic management unit that relay wireless signals to the runway traffic management unit; and
a plurality of wireless runway incursion sensors that are located in proximity of at least one airport runway that detect metallic objects, wherein if a metallic object is detected, the wireless runway incursion sensors that detect the metallic object send signals to the runway traffic management unit, the wireless signal being an indication that the metallic object is one of entering the runway and leaving the runway;
wherein the wireless runway management unit receives one or more signals from at least one of the plurality of wireless runway incursion sensors through at least one of the wireless relay devices indicating that a metallic object is one of entering a runway and leaving a runway, sends a notification to a ground control operator that the runway is occupied based on the one or more received signals, determines that the metallic object has cleared the runway, and sends a notification to ground control that the metallic object has cleared the runway based on the cleared runway determination.
